(19) United States
(12) Patent Application Publication
(10) Pub. No.: US 2012/0319341 A1
(43) Pub. Date: Dec. 20, 2012

(54) PORTABLE EXPANDABLE WORKBENCH

(76) Inventor: SAM KOFFSKI, Duncan (CA)

(21) Appl. No.: 13/204,629

(22) Filed: Aug. 5, 2011

Related U.S. Application Data
(60) Provisional application No. 61/371,456, filed on Aug. 6, 2010.

(51) Int. Cl. B25H 1/04

(52) U.S. Cl. 269/55

(57) ABSTRACT

A portable expandable work bench is expandable in a longitudinal direction to increase its working surface and so support a power tool for operating on a work piece. The non-expandable portion of the work bench is a rectangular hollow body having a generally planar a top work surface. The expandable portion of the work place is nested inside of the hollow body. A second expandable portion is nested within the first expandable portion and a third expandable portion is nested within the second expandable portion.

### CROSS-REFERENCE TO RELATED APPLICATIONS

This application claims the benefit of U.S. Provisional Patent Application No. 61/371,456 filed in the United States Patent and Trademark Office on Aug. 6, 2011.

### FEDERALLY SPONSORED RESEARCH

N/A

### FIELD OF THE INVENTION

This invention relates to the field of wood working and particularly to a workbench and specifically to a portable expandable workbench.

### BACKGROUND

Various forms of portable and collapsible workbenches are known in the art. The advantage of a portable and collapsible workbench is that it may be used in confined spaces where the workbench cannot be permanently deployed. There is still a need for a portable workbench that may be used in confined spaces, such as a small garage, is easily stored and can be made of light-weight materials for ease of movement and inexpensive manufacture. Furthermore, there is a requirement for a portable workbench that is expandable and is capable of temporarily mounting power tools.

### OBJECTIVES OF THE INVENTION

It is an object of the present invention to provide a workbench that is expandable, portable and collapsible for easy storage in a confined space.

It is a further objective of the present invention to provide a workbench that has an expandable working surface.

Another objective of the invention is to provide a portable, collapsible and expandable workbench that can temporarily mount a power tool.

A further objective of the invention is to provide a workbench that is made from lightweight and recycled materials.

Yet another objective of the invention is to provide a workbench that can be easily disassembled and the disassembled parts stored in a convenient and accessible manner.

Yet another advantage is that it is easy and inexpensive to manufacture.

### SUMMARY OF THE INVENTION

In accordance with the present invention, a portable, collapsible workbench assembly having an expandable work surface is provided that can be disassembled and stored mounted to a vertical surface such as a wall. The workbench assembly includes four supporting legs that are dismountable from the horizontal working surface. The four legs are generally of equal length but can be individually vertically adjusted to accommodate uneven floor or ground surfaces. Each leg is temporarily fixed to the working surface by a bracket comprising a U-shaped channel and a spring biased bracket. The expandable working surface of the workbench comprises a first series of adjacent and parallel rectangular members that slide into and out of a non-expandable table top in a telescoping relationship. The members can be hollow members or solid members made from a suitable light weight material and so they are economical to make. In one embodiment of the invention, the sliding members slide through a dove-tail joint comprising a key on the sliding members meshed with a slot on a separating member within the non-expandable tabletop. When in the storage configuration the working tabletop surface is at its smallest length. At its longest length the working surface is almost twice the length of the non-expanding tabletop. To prevent the sliding members from disengaging the tabletop at the longest length there are suitable stops mounted on the ends of the sliding rectangular members. A second series and a third series of parallel adjacent rectangular members are disposed in a sliding and telescoping relationship within the exterior end of the first series and the opposite end of the non-expandable tabletop. Within the second and third series there is horizontally disposed in a storage configuration a first and a second work piece support structure. The first and the second work piece support structures comprise a pair of dowels or rectangular members fixed to a supporting member. The first and second work piece support structures can be removed from the ends of the second and third series and mounted vertically to the end pieces of the second and third series. When in the supporting vertical configuration the first and second work piece support structures can support the end of a work piece at an adjustable height for operation by a power tool such as a saw.

The non-expanding table top comprises a first rectangular panel of material to form a tool mounting surface. The table and its various components can be made from a variety of materials including wood or recycled plastic materials.

To disassemble the work bench, the working surface is collapsed to its smallest length and legs are removed from the leg support brackets. The workbench can be hung on a wall using a suitable hanging bracket.

Various other features and advantages of the present invention will become apparent from a review of the following detailed description taken with the drawings.

### BRIEF DESCRIPTIONS OF THE DRAWINGS

FIG. 1 is a top perspective view of one embodiment of the invention.

FIG. 2 is a front view of one embodiment of the invention.

FIG. 3 is a side view of one embodiment of the invention.

FIG. 4 is another top perspective view of the invention of FIG. 1.

FIG. 5 is a view of a bracket of one embodiment of the invention.

FIG. 6 is a view of another view of the bracket of one embodiment of the invention.

FIG. 7 is a view of an alternative bracket used in one embodiment of the invention.

### DETAILED DESCRIPTION OF THE INVENTION

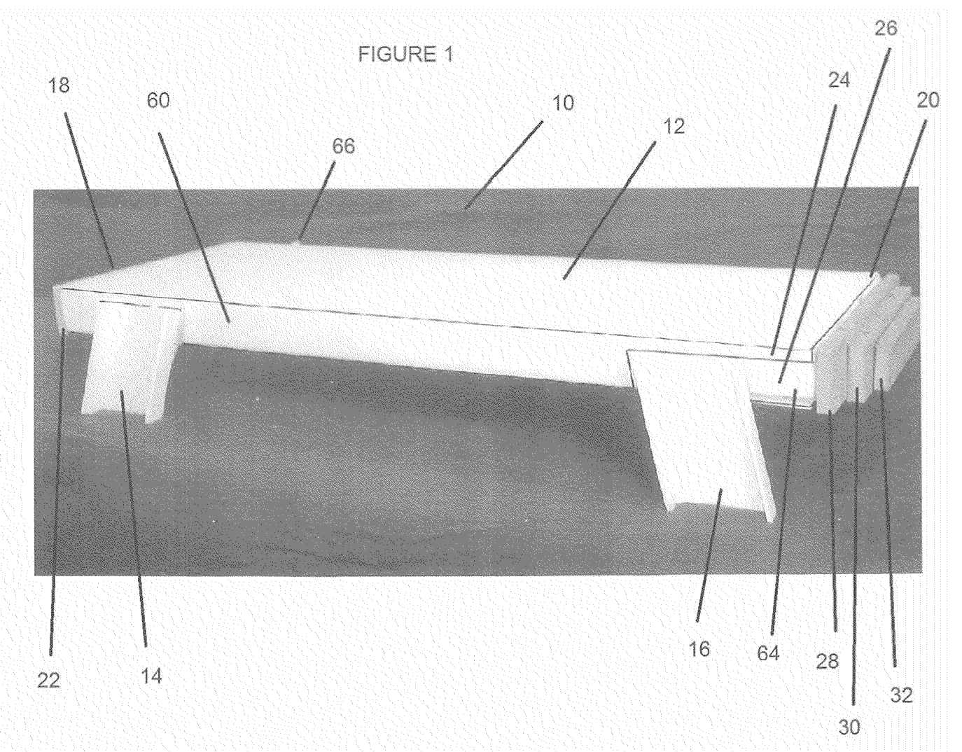

Referring to FIG. 1 there is shown a top perspective view of one embodiment of the invention 10 which is a portable expandable work bench. The work bench is shown in its collapsed configuration and comprises a working surface 12 and four leg channels of which 14 and 16 are shown. In the collapsed configuration the work bench 10 comprises a first end 18 and a second end 20. Attached to first end 18 is a fixed cap piece 22. The second end 20 is the expanding end of the work bench. Cut out 24 illustrates the first expanding portion 26 of the work bench which is nested within the working surface 12. The outside end of the first expanding portion 26 is capped with a cap piece 28. Within the first expanding portion 26 is nested a second expanding portion (illustrated in subsequent figures) having a cap piece 30. Nested within the second expanding portion (illustrated in subsequent figures) is a third expanding portion having a cap piece 32.

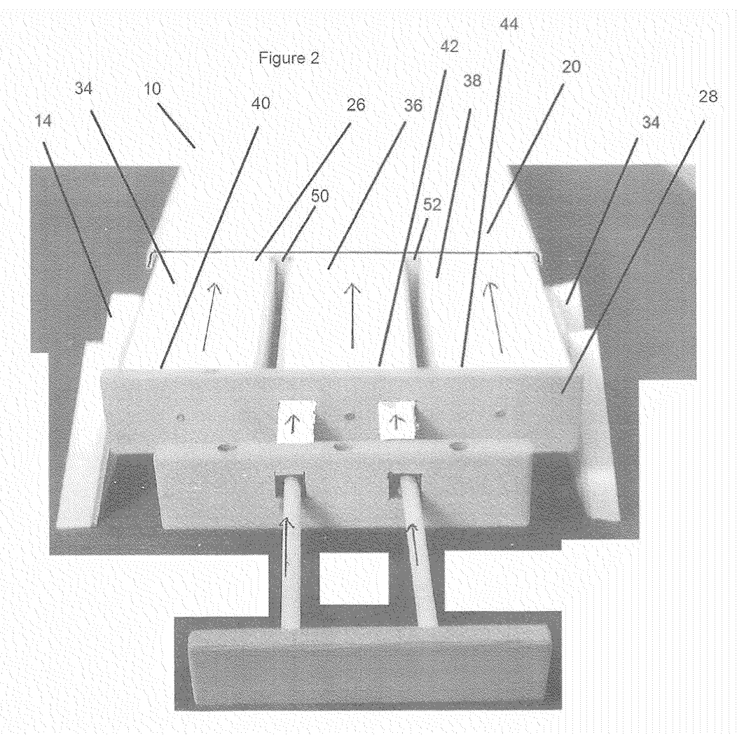

Referring to FIG. 2, there is shown the invention 10 and a top perspective view of the second end 20. The working surface 12 is illustrated as well as leg channels 14 and 33. Expanding portion 26 is capped with cap piece 28. In the embodiment shown, the first expanding portion 26 comprises three rectangular sliding members 34, 36 and 38 having their respective external ends 40, 42 and 44 fixed to the inside surface 46 of cap piece 28. The rectangular sliding members telescope into respective receiving chambers created by guide members 50 and 52 which run parallel to the rectangular sliding members. The rectangular sliding members are in sliding contact with the walls of the receiving chambers and at least one side of the respective guide member. The rectangular sliding members may be pulled out to a desirable length or pushed in using a modest hand force. When deployed outside of the receiving chambers the rectangular sliding members will remain in position due to frictional contact between the sliding members and the chamber walls. While the embodiment shown in FIG. 2 shows three rectangular sliding members telescoping in and out of three receiving chambers there can be as few as one sliding member or more than three sliding members.

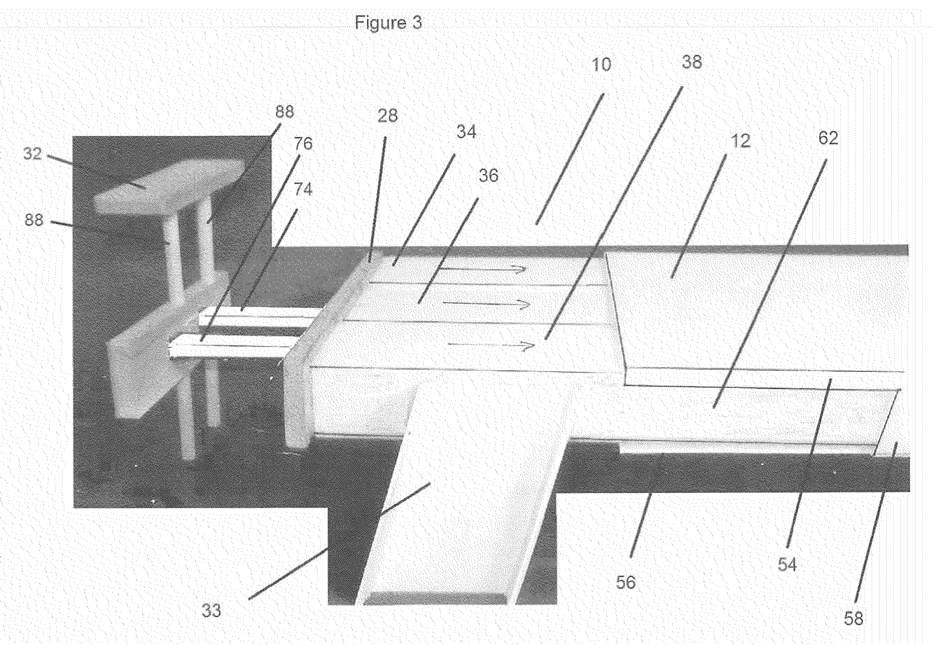

Referring to FIG. 3, there is shown a side view of one embodiment of the invention 10 comprising a hollow rectangular body 54 having a top side comprising a planar working surface 12, a bottom surface 56, a left side 58 and a left side 60 (See FIG. 1) which is not shown in this view. Rectangular sliding members 34, 36 and 38 are illustrated in a deployed position. The sidewall 58 is cut away to form a rectangular slit 62 to accommodate the leg bracket 33 attached to the outside of rectangular member 38 in its collapsed position. Leg bracket 16 is similarly accommodated by slit 64. Leg brackets 14 and 66 are fixed to the left side 60 and the right side 58 respectively of the non-expanding portion of the rectangular hollow body 54.

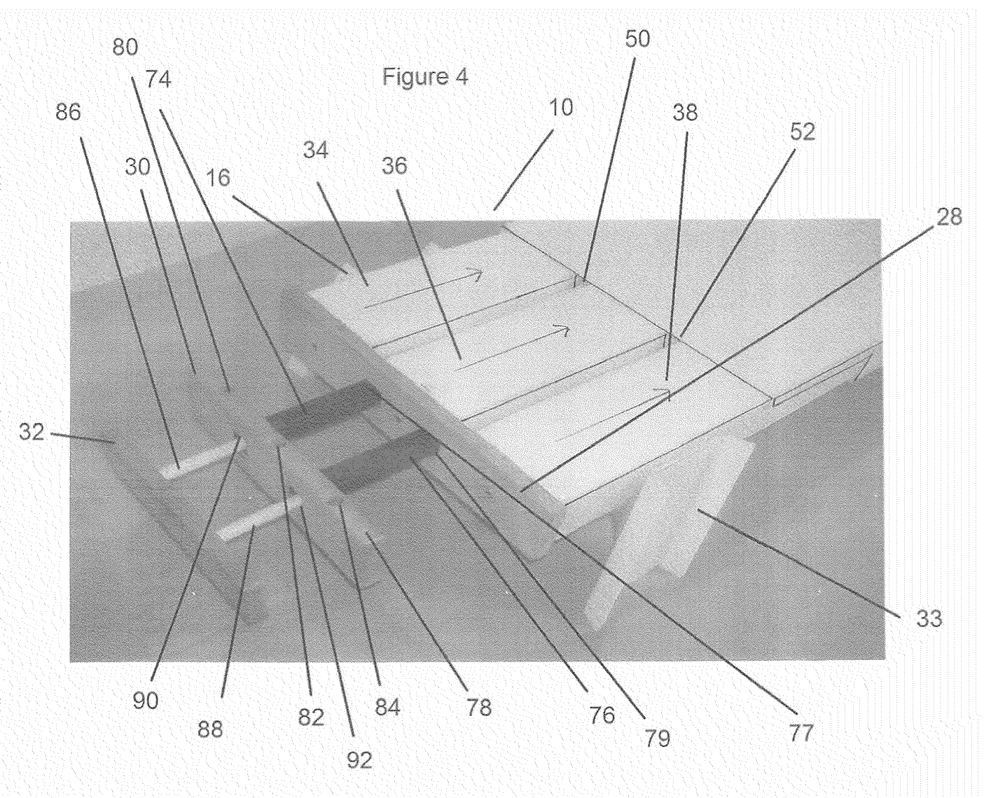

Referring to FIG. 4, there is shown another front perspective view of one embodiment of the invention 10. Rectangular sliding members 34, 36 and 38 are shown in a deployed position supported by leg brackets 16 and 33. Guide members 50 and 52 are shown separating rectangular sliding members 34 and 36 and rectangular sliding members 36 and 38 respectively. Telescoping in and out of cap piece 26 are two rectangular members 70 and 72. Cap piece 28 is fixed to the outside ends of the rectangular sliding members 34, 36 and 38. Cap piece 30 is fixed to rectangular sliding members 74 and 76 which slide telescopically into and out of the centre rectangular sliding member 36 through rectangular apertures 77 and 79. Cap piece 30 is a rectangular member which is disposed vertically and parallel to cap piece 28. The top surface 78 of cap piece 38 comprises three holes 80, 82 and 84 which run through the member. As shown in FIG. 1, cap piece 30 slides into an abutting relationship with cap piece 28 when not in an expanded configuration. Cap piece 32 is fixed to the outside ends of members 86 and 88. These members 86 and 88 are shown as cylindrical dowels but may also be rectangular. The member 86 slides telescopically into rectangular member 74 through aperture 90 and member 88 slides telescopically into rectangular member 76 through aperture 92.

Referring now to FIGS. 3 and 4, cap piece 32 and members 86 and 88 form a support bracket for a work piece placed on the expanded work bench. The ends of the members 86 and 88 are inserted into two adjacent holes of the three holes 80, 82 and 84. The members 86 and 88 are fixed in position while inserted into the holes by such means as pins or clamps. Referring to FIG. 1, when the support bracket is in a storage position the cap piece 32 abuts against cap piece 30.

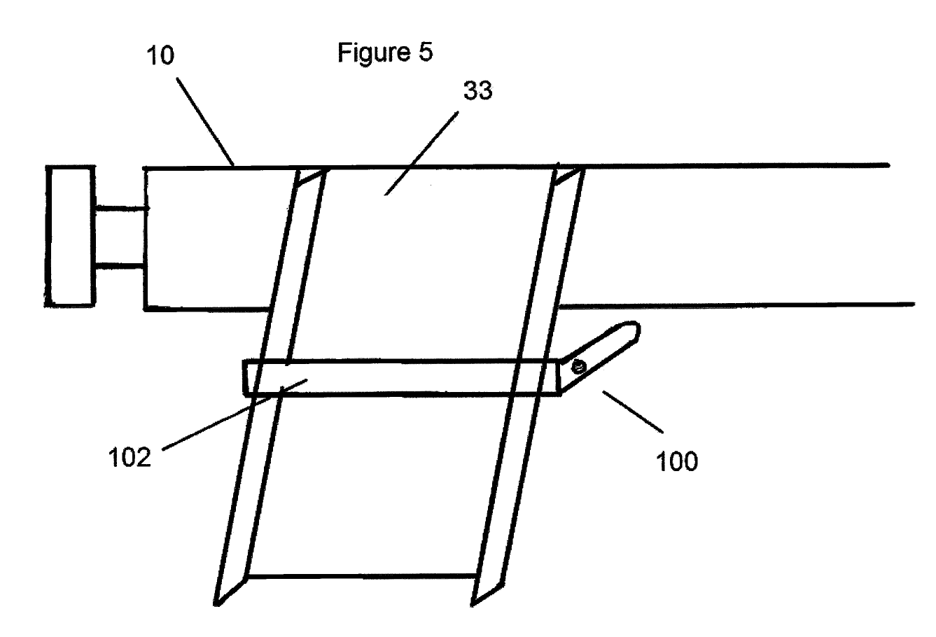

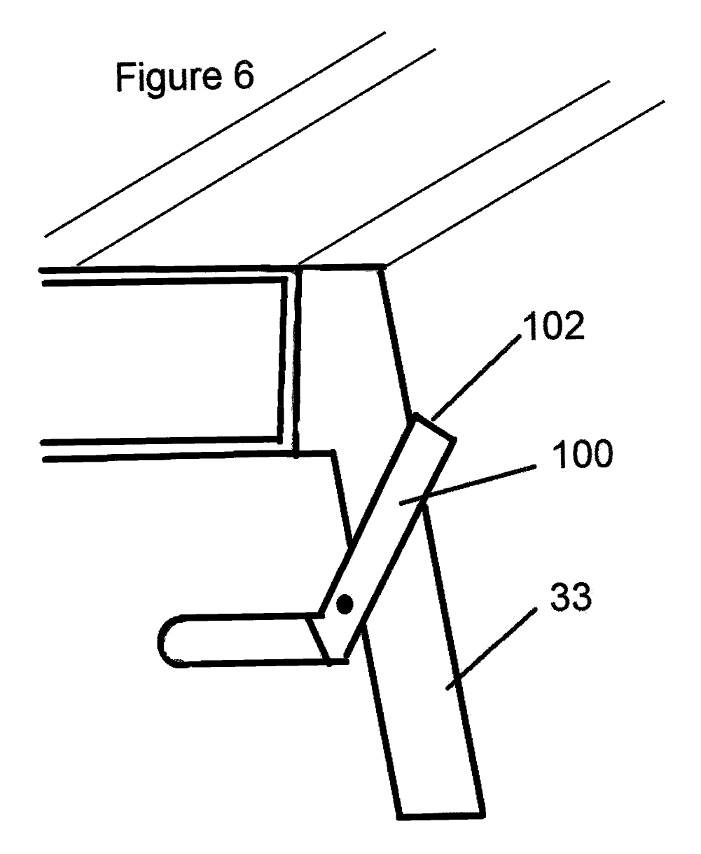

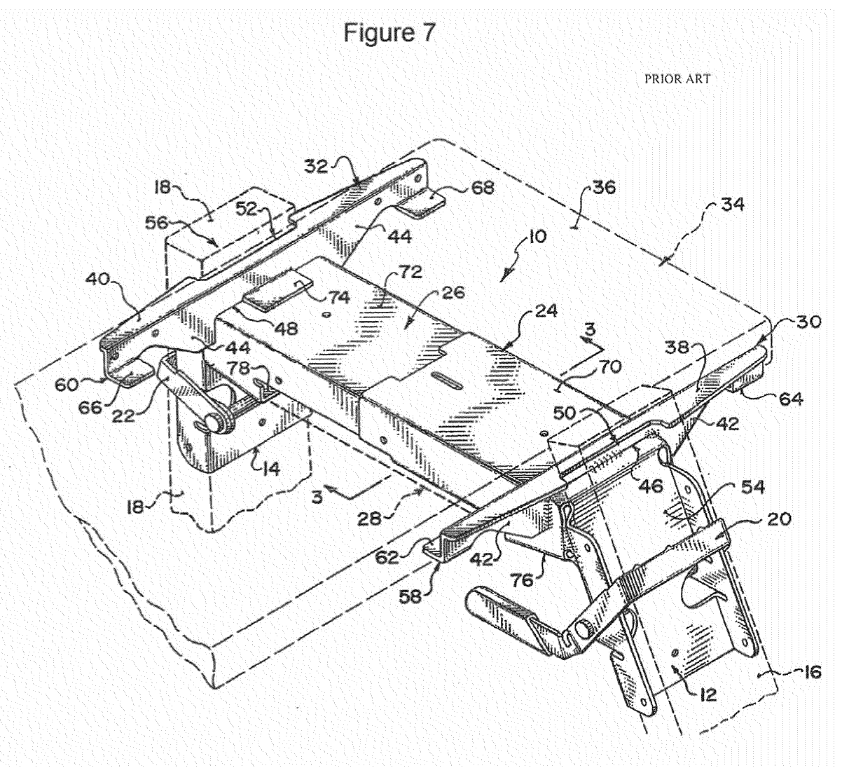

Referring to FIG. 5 and FIG. 6, there is shown one embodiment of a leg clamp 100 of the invention 10. In the embodiment shown, the clamp is a spring clamp that holds a leg into place temporarily by compressing bar 102 against a section of, for example, 2×4 lumber set into the channel bracket 33. In this embodiment, the channel bracket 33 is mounted to the sliding rectangular member 38. Other types of brackets can be used to fix the temporary legs to the work bench. Once such bracket is shown in FIG. 7 and is subject of Canadian patent application #2011006 by Koffski et al. now expired.

By the foregoing, it is clear that the work bench of the present invention provides a user with many advantages. The workbench is directly mountable to a vertical surface such as a wall for storage. It is easily disassembled and all parts can be stored together. The working surface can be expanded up to several feet to accommodate long work pieces The ability to also raise or lower the workbench legs individually to a desired height also enhances use of the workbench for various types of uses.

Although the present invention has been illustrated with respect to preferred embodiments, it shall be understood that various other changes and modifications may be made to the invention which fall within the scope of the claims appended hereto.

What is claimed is:

1. A portable expandable work bench expandable in a longitudinal direction between a non-expanded configuration to a partially expanded configuration or a fully expanded configuration, said work bench comprising:
a. a rectangular hollow body having a generally planar a top work surface for mounting a power tool and supporting a work piece, a bottom surface, a back wall, an open front end, a left side wall and a right side wall;
b. an first expanding portion nested within said rectangular hollow body, said expanding portion having a first end remaining within the rectangular hollow body and a second end disposed outside of said open front end, a left side and a right side;
c. wherein said first expanding portion is movable in said longitudinal direction between said non-expanded configuration and said partially expanded configuration or said fully expanded configuration; and,
d. a first, second, third and fourth channel brackets fixed to the expandable work bench for temporary leg attachment having adjustable heights.

2. The work bench of claim 1 wherein the first expanding portion comprises a plurality of laterally spaced, elongate rectangular sliding members each having a free first end remaining within the rectangular hollow body and a second end disposed out of the open front end and fixed to a first cap piece.

3. The work bench of claim 2 wherein the free first end of each rectangular sliding member includes a stopping member so that the first end of each rectangular sliding member cannot be pulled through the open front end of the rectangular hollow body when in said fully expanded configuration.

4. The work bench of claim 3 wherein each rectangular sliding member is telescopically received by a respective chamber within the rectangular hollow body.

5. The work bench of claim 4 wherein each of said respective chambers is separated from an adjacent chamber a guide member.

6. The work bench of claim 5 wherein each of the respective chambers comprises a top wall, a bottom wall, a left wall and a right wall, and wherein each of the rectangular sliding members comprises a top surface, a bottom surface, a left surface and a right surface so that when the expanding portion is pulled out of the rectangular hollow body, said top wall, said bottom wall, said left wall and said right wall are in mild frictional contact respectively with said top surface, said bottom surface, said left surface and said right surface the result being that a mild hand force is necessary to slide the expanding portion in and out of the rectangular body and once the expanding portion is in a desired configuration it will remain frictionally fixed in said desired configuration.

7. The work bench of claim 6 wherein said first channel bracket is fixed to said left side wall of the rectangular hollow body, said second channel bracket is fixed to said right side wall of the rectangular hollow body, said third channel bracket is fixed to said left side of the expanding portion and said fourth channel bracket is fixed to said right side of the expanding portion.

8. The work bench of claim 7 wherein a front portion of said left side wall of the rectangular hollow body and a front portion of said right side wall of the rectangular hollow body are cut back a predetermined distance to receive the third and the fourth channel brackets respectively when the expanding portion is fully nested within the rectangular hollow body and said first cap piece is abutting against the open front end of the rectangular hollow body.

9. The work bench of claim 8 wherein the plurality of laterally spaced, elongate rectangular sliding members comprises three members.

10. The work bench of claim 8 wherein a second expanding portion is nested within the first expanding portion, said second expanding portion having a first end remaining within the first expanding portion and a second end disposed outside of the first expanding portion; and wherein the second expanding portion is movable in the longitudinal direction between the non-expanded configuration and the partially expanded configuration or the fully expanded configuration.

11. The work bench of claim 10 wherein said second expanding portion comprises at least two laterally spaced, elongate rectangular sliding members having an inside first end disposed within the first expanding portion and a second outside end fixed to a second cap piece, and wherein said inside first end includes a stopping member so that when the second expanding portion is pulled out of the first expanding portion said stopping member will prevent the elongate rectangular sliding members from leaving the first expanding portion.

12. The work bench of claim 11 wherein said at least two laterally spaced, elongate rectangular sliding members of the second expanding portion comprise a left member telescopically received into the first expanding portion through a first rectangular orifice within said second cap piece and a right member telescopically received into the first expanding portion through a second rectangular orifice within the second cap piece.

13. The work bench of claim 9 and claim 12 wherein the at least two rectangular sliding members of the second expanding portion are nested within a central sliding member of the first expanding portion.

14. The work bench of claim 12 wherein a third expanding portion is nested within the second expanding portion, said third expanding portion removable from the second expanding portion and comprising a first member and a second member each having a free first end for telescopic placement within a first and second aperture within the second cap piece and a second end fixed to a third cap piece.

15. The work bench of claim 14 wherein the second cap piece further comprises a plurality of bores drilled from a top surface thereof through the second cap piece.

16. The work bench of claim 15 wherein at least two adjacent bores of said plurality of bores each receive a first free end of said first and second members of the third expandable portion thereby forming a vertically oriented work piece support.

17. The work bench of claim 16 wherein said vertically oriented work piece support is fixed at a desired height with respect to the second cap piece by fixing means.

18. The work bench of claim 7 wherein the first, second and third channel brackets comprise a channel for receiving a piece of wood for a support leg, wherein said piece of wood is held in place by a biased clamp.

19. The work bench of claim 18 wherein the first, second, third and fourth brackets are removable from the work bench.

20. The work bench of claim 7 wherein the first and second brackets are connected by a first bracing member extending transversely across the bottom of the hollow rectangular body and the third and fourth brackets are connected by a second bracing member extending transversely across the bottom of the hollow rectangular body.
